(19) United States
(12) Patent Application Publication
(10) Pub. No.: US 2016/0247352 A1
(43) Pub. Date: Aug. 25, 2016

(54) METHODS, SYSTEMS, AND PROGRAMS FOR PLAYING AND REPLAYING AN ONLINE GAME

(71) Applicant: Kevin William Rogers, Oviedo, FL (US)

(72) Inventor: Kevin William Rogers, Oviedo, FL (US)

(21) Appl. No.: 15/145,651

(22) Filed: May 3, 2016

Related U.S. Application Data
(63) Continuation of application No. 13/484,126, filed on May 30, 2012.
(60) Provisional application No. 61/606,634, filed on Mar. 5, 2012.

(51) Int. Cl. G07F 17/32

(52) U.S. Cl. CPC G07F 17/3241; G07F 17/3293

(57) ABSTRACT

A method of recording and playing back card play of players in a multi-player card game involving wagering, in which sequential rounds are played in multiple simultaneous tables, and in which, in a round on a table, a first player cannot see all the cards dealt to other players, the method including generating a round review animation illustrating how the first round was played, in which cards dealt to all players of the first round are revealed, and in which game play inputs made by players are indicated. Systems and computer program code are also provided.

### CROSS REFERENCE TO RELATED APPLICATION

This is a continuation of U.S. patent application Ser. No. 13/484,126, filed May 30, 2012, naming Kevin William Rogers as inventor, attorney docket RGRS-002, titled SYSTEMS, METHODS, AND PROGRAMS FOR PLAYING AND REPLAYING AN ONLINE GAME, incorporated herein by reference, which in turn claims the benefit of U.S. Provisional Patent Application Ser. No. 61/606,634 filed Mar. 5, 2012, attorney docket RGRS-001.

### TECHNICAL FIELD

The technical field comprises online game playing.

### BACKGROUND

Various online games are available and known in the art. Users do not always know if they have made the best moves all the time. For example, with poker, a player can make all the right moves and lose, and vice versa, make all the wrong moves and win. This makes it hard for a user to determine what he or she did correctly or incorrectly.

Playing games of skill online, such as card games where wagers can be placed, is different compared to live play in a brick and mortar card room. With live play, a dealer, eye in the sky, and other players police the table where they are playing. Online games have none of those benefits, and therefore cheating is much easier. For example, some players may collude via text messages, phone calls, or other means of communication, or may be in the same room and disguise their IP addresses, or share information about their hands to be sure to beat another player.

### BRIEF DESCRIPTION OF THE VIEWS OF THE DRAWINGS

FIG. 1 is a block diagram of a system in accordance with various embodiments.

FIG. 2 is a block diagram showing additional details of the system shown in FIG. 1, in accordance with various embodiments.

FIG. 3 is a functional block diagram illustrating options available to a user, including the ability to review or play back a hand, in accordance with various embodiments.

FIG. 4 is a functional block diagram illustrating options available to an administrator, including the ability to review or play back a hand, in accordance with various embodiments.

FIG. 5 is a functional block diagram illustrating options available to a super-administrator, including the ability to add or remove administrators, in accordance with various embodiments.

FIG. 6 is a functional block diagram illustrating options available to a super-administrator, including the ability to set the amount of time for which information should be saved, in accordance with various embodiments.

FIG. 7 is a screen shot of game list administration, in accordance with various embodiments.

FIG. 8 is a logic flow diagram that also includes examples of screen shots, in accordance with various embodiments.

FIG. 9 is a logic flow diagram that also includes examples of screen shots, in accordance with various embodiments.

FIG. 10 is a screen shot showing availability options settings in accordance with various embodiments.

FIG. 11 is a database schema diagram in accordance with various embodiments.

FIG. 12 is a screen shot showing features of various embodiments, during normal card play.

FIG. 13 is a map illustrating how FIGS. 13A and 13B are to be assembled.

FIG. 13A is a first portion of a screen shot showing features of various embodiments, with card play being replayed with cards revealed. FIG. 13B is a second portion of a screen shot showing features of various embodiments, with card play being replayed with cards revealed.

### DETAILED DESCRIPTION OF THE ILLUSTRATED EMBODIMENTS

Some embodiments provide systems, methods, and programs for training users in online game playing. Some embodiments provide systems, methods, and programs for detecting online collusion of online game players. More particular embodiments provide systems and methods for both training users in online game playing and for detecting online collusion of online game players.

Various embodiments provide a feature, herein referred to as hand review or session replay, which provides a replay of a card game such as poker, and replays a hand that has concluded. In some embodiments, a user can replay a portion of a hand or game and can use navigation controls such as play, pause, rewind, fast-forward, etc. In some embodiments, all hole cards are exposed, for every player in the hand. In some embodiments, the replay will be available for the player for only a predetermined period of time, e.g., for 24 hours after a hand, game, or session has concluded. In other embodiments, the replay is available substantially indefinitely, e.g., as long as there is storage room to keep it.

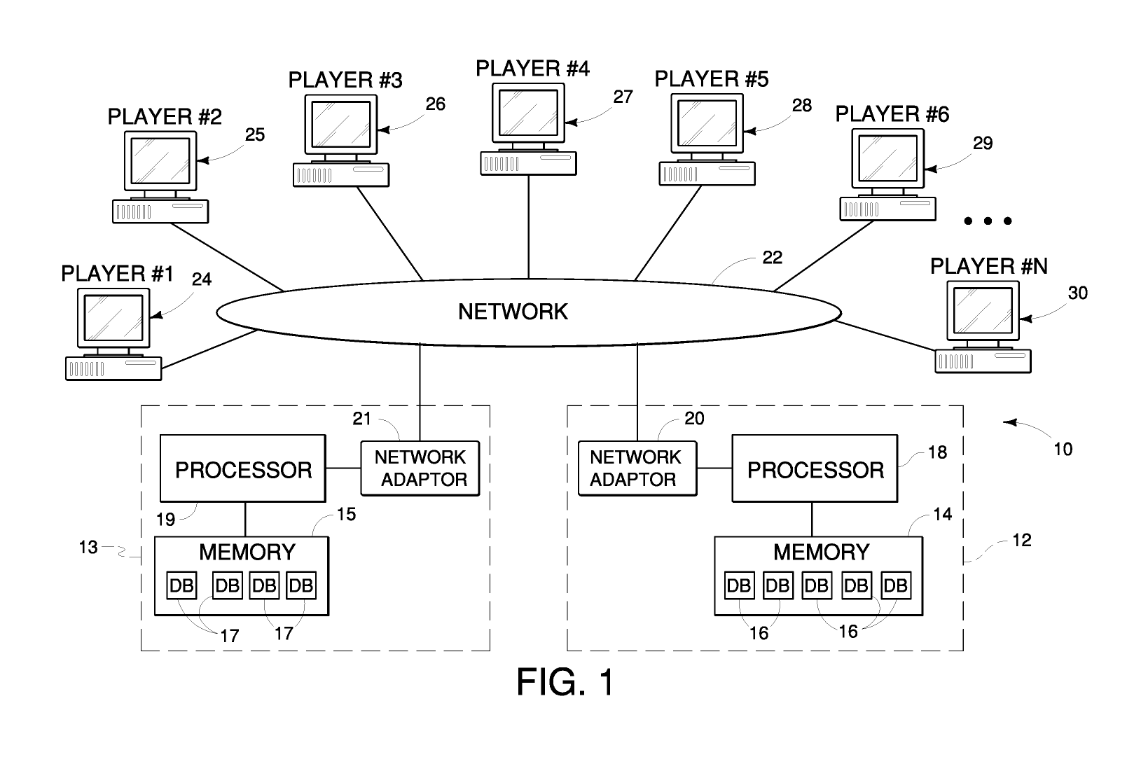

In some embodiments, only the card players at a given table are eligible to view their hand replay. For example, if table A has five players playing Texas Hold'em, only those five players have access to view the replay of that particular hand on table A. In other embodiments, only those five players plus a system administrator or administrators have access. The system administrators may be the owners or operators of the server 12 shown in FIG. 1, or the “house” that is hosting the game on the server 12, or another server 13 controlled by the operators of the review feature or website.

In some embodiments, a fee is charged to view a replay of one or more hands played. In other embodiments, a fee is not charged.

In some embodiments, hand review is added to an online poker site as a learning tool for all players.

In some embodiments, a third party offers various or all features disclosed herein, including hand review, for a daily, weekly, monthly, yearly or lifetime membership fee. In some embodiments, hand review is offered as an add-on feature for existing and future websites.

Poker is a unique game in the world in that a player can make all the right moves and lose, and vice versa, make all the wrong moves and win. Hand review provides players with information that is useful to determine, with conviction, what the player did correctly, and what the player did incorrectly. Hand review provides the answers to questions such as: “did he have it,” “did I make a good lay down,” “should I have raised,” “should I have folded,” etc. Various types of players, from the most experienced player, to the card player playing his or her first hand, benefits from the features disclosed here. Hand review can help improve the skill level of any type of card player, and of players of all types of skill levels.

Various teams, and players, for various sports, use game film to improve their play, and strategize for future opponents. Football, soccer, baseball, basketball, hockey, tennis, golf, etc. use game film to do that.

In some embodiments, game review (or hand review in the case of card games) is provided for online games, such as poker, a game which involves skill. In some embodiments, when a player wants to see his or her session, he or she will go to a review website or game website, login and will be able to see every hand in which they participated, whether they played ten minutes at one table, or eight hours at ten tables. In some embodiments, the ability to review also serves another purpose: to detect collusion.

Hand review, in addition to acting as a learning tool, can also help detect cheating. Online poker is different from live play in a brick and mortar card room. With conventional card rooms, the dealer, eye in the sky, and other players police the table at which they are playing. Online poker has none of those benefits, and therefore cheating is much easier. In live play, the consequences are harsh if players are caught communicating to one another about their hole cards. While playing online, players are able to cheat by exchanging information via texting, on the phone, or using (for example) wireless Internet cards with different IP addresses, to name a few. In accordance with various embodiments described herein, suspicious play can be detected, reported and confirmed faster. Various embodiments provide an online game room with session review that enables players to police themselves in addition to improving their game. Another benefit from this is added revenue via advertising, in some embodiments.

Attention is directed to U.S. Pat. No. 7,604,541 to Aiken et al., which is incorporated herein by reference. This reference describes how collusion in online gaming is a problem. In some embodiments, some of the features described in the incorporated patent are integrated into or used in connection with some or all of the features of the systems and methods described herein.

Attention is also directed to PCT Publication No. WO/2008/091809 to Miller et al., which is incorporated herein by reference. This reference discloses a method and system for tracking card play.

FIG. 1 shows a system 10 in accordance with various embodiments. The system 10 includes a server 12 including memory 14 defining one or more databases 16. The database or databases 16 store data. The server 12 also includes one or more processors 18 in communication with the memory 14. The server 12 also includes one or more network adapters 20 enabling communication with a network 22 such as the Internet. Game players, such as card players, use terminals or client computers 24, 25, 26, 27, 28, 29, 30 etc. to communicate with the server 12 and to together play a multi-user game, such as a game of cards. The server 12 and client, operating together, provide various of the features described herein. For example, in some embodiments, the server 12 records and stores hands that are played and generates a video file of a card replay, which file is transmitted to a client machine and played on the client machine using a video player residing on the client machine. In some embodiments, the clients download a software program from the server 12, which program generates an interface and is used to play games with other players.

In some embodiments, the system 10 includes a separate server 13 for providing game review. The server 13 provides additional functionality (e.g., a retrofit) to a pre-existing game site hosted by server 12. The server 13 includes memory 15 defining one or more databases 17. The database or databases 17 store data as will be described below. The server 13 also includes one or more processors 19 (may be multi-core) in communication with the memory 15. The server 13 also includes one or more network adapters 21 enabling communication with the network 22. The server 13 may be operated by a different service provider than the provider of the game on server 12. Game players, such as card players, use terminals or client computers 24, 25, 26, 27, 28, 29, 30 (e.g., computers, terminals, workstations, netbooks, smart phones, smart appliances, Internet TVs, etc.) to communicate with the server 13 to review games that have been played. In these embodiments, the server 13, instead of (or in addition to) the server 12, records and stores hands that are played and generates a video file of a card replay, which file is transmitted to a client machine and played one the client machine using a video player residing on the client machine. In some embodiments, the clients download a software program from the server 13 (or 12), which program generates an interface and is used to review games.

In various embodiments, hand review serves as a learning tool. Many times during the course of play, a card player has a decision to make based on the action taking place at their table.

Assume that you are a player in an online poker game. You have pocket queens; there is a raise and a re-raise before the action gets to you. You decide to fold, and then everyone folds to the re-raiser as well. How do you know if you made the right or wrong move? Various embodiments provide a hand review that provides that answer.

Some embodiments allow users to play any of various available card games and later replay hands with all players' cards showing. In some embodiments, players can choose from a variety of games, such as some sub-combination of the following: 3-5-7 Poker, 7-14-21, Asia Poker, Asian Stud, Australian Blackjack, Baccarat, Baccarat Gold, Bet the Deck, Bet the Deck version 2, Bonus Six, Boston 5, Break Poker, California Three Card Poker, Card Craps, Card Sharks, Caribbean Stud Poker, Casino Hold 'em, Casino War, Catch A Wave, Chemin De Fer, Crazy 4 Poker, Dealer Bluff, Deuces Wild, Double Down Stud, Double Exposure, Double Fortune Baccarat, EZ Pai Gow Poker, EZ Pai Gow Poker (Nevada), Flop Poker, Four Card Poker, Hi Low Pai Gow Poker, High Card Flush, Let It Ride, Mini Tex, Mississippi Stud, Mulligan Poker, No-Flop Pineapple, No-Fold Oasis Poker, Oasis Poker, One Up, Pai Gow Poker, Pontoon, Punto Banco, Pyramid Poker, Q Poker, Red Dog, Riverboat Hold 'em Poker, Screw Your Neighbor, Siete y Media, Super Pan 9, Tequila Poker, Texas Hold 'em, Texas Hold 'em Bonus, Texas Shootout, Three Card Baccarat, Three Card Poker, Three Card Second Chance Poker, Triple Action Hold 'em, Two Card Joker Poker, Ultimate Texas Hold 'em, Ultimate Three Card Poker, World Poker Tour 3× Raise Hold 'em, World Poker Tour All in Hold 'em. In other embodiments, only one game is available to be played (e.g., one game per domain or one game per downloaded program).

These games are known in the art and the rules of the games will not be described herein in detail. These games are provided by way of example only. Different games, games that used to be played at casinos (online or bricks and mortar) but have been discontinued, new games with new rules, made up games, or additional games could be provided for users to play. In some embodiments, the server 12 (or servers 12 and 13) are configured to allow players to play any desired game, from a predetermined list of games, and later replay hands or sessions. While these games are mostly card games, various embodiments provide a replay of any other multi-player game of skill, including, but not limited to, games in which wagering is possible, and games in which players are playing against each other, at least to some extent.

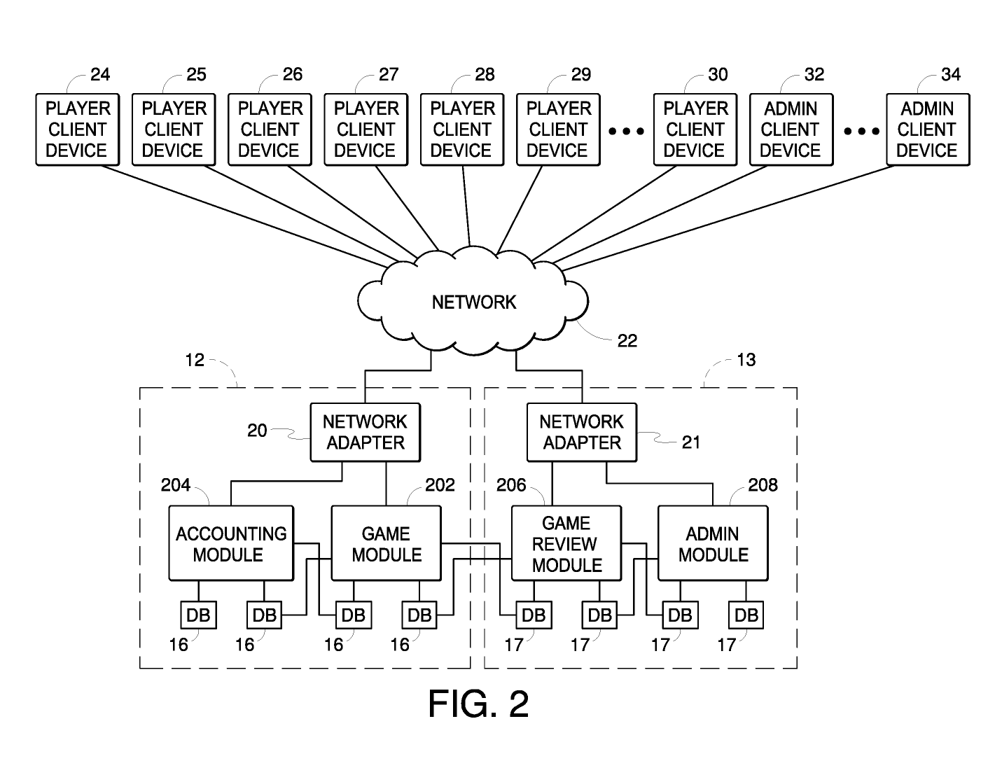

FIG. 2 is a block diagram showing additional details of the system shown in FIG. 1, in accordance with various embodiments.

In the embodiment of FIG. 2, players, using any of player client devices 24-30, may play games by contacting a game module 202 via the network 22. In some embodiments, an accounting module 204 is provided which receives payment from a player (e.g., via credit cards, debit cards, online checks, Paypal™ or similar payment mechanisms), credits the player's account, allows the player to make wagers based on the amount in the account, credits winnings to the player's account, and allows a player to withdraw funds up to their account value (e.g., back to a credit card, Paypal account, or bank account).

Players, using any of the player client devices, may also request game review from game review module 206. Administrators, using admin client devices 32 or 34 may also access game module 202 as well as game review module 206, to review games played, and may also access admin module 208 to perform administrative functions. There may be two types of administrators. One type of administrator is employees or people who are otherwise associated with casinos or who manage the games played in game module 202. There may be different administrators at different casinos, or different administrators who manage different games. The other type of administrator manages the system 10 and is a super-administrator having control over other administrators. The game module, accounting module 204, game review module 206, and admin module 208 have respective databases 16 and 17 and share some or all databases 16 and 17. Database organization will be described in greater detail below

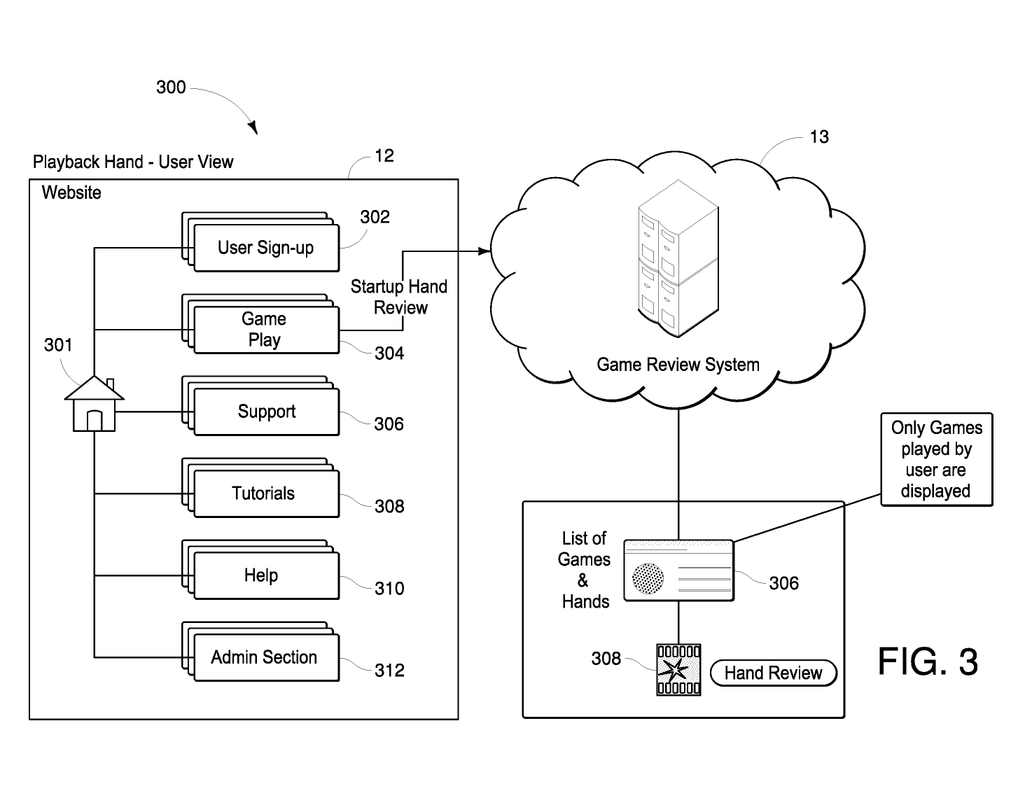

FIG. 3 is a functional block diagram illustrating a system 300 providing options to a user, including the ability to review or play back a hand, in accordance with various embodiments. In the embodiment shown in FIG. 3, game review is provided by a separate server 13 from the server 12 used for game play. In other embodiments, the functions of servers 12 and 13 are combined or provided by the same company or operator.

In FIG. 3, server 12 includes user sign-up web pages 302 using which a user or player can register (e.g., with a user ID, password) to be able to play any of the games hosted on the server 12. In some embodiments, the user sign-up pages 302 also require that the user identify a funding source, such as by providing a credit or debit card. In other embodiments, identifying a funding source happens later, after registration. As used herein, the term page refers to a web page or pages, a dialog, screen, portion of a screen, scrollable screen, pop-up, or other form of web interface.

The system 300 further includes game play pages 304 using which a user may play games such as the card games described above. From the game play pages 304, a user may request game review or otherwise interact with game review functions, from server 13. In the illustrated embodiment, only games played by the user may be accessed for game review. In some embodiments, a page (or pages) 306, including a list of games and hands that the user played, is provided to the user. This may be provided in response to a search or there may be default criteria used to generate the list (e.g., all games or most recent of a predetermined number of games or hands played within a predetermined time period). In response to a user specifying a hand to review, a game review animation or video 308 is generating and provided to the user. In some embodiments, the video 308 illustrates substantially the same thing that is illustrated during normal game play, except that all cards dealt are shown face up (and advertising may be added or be different).

The system 300 further includes some or all of support pages 306, tutorial pages 308, and admin pages 312. The pages 302, 304, 306, 308, 310, and 312 may be accessed, in some embodiments, from a casino or game provider home page 301.

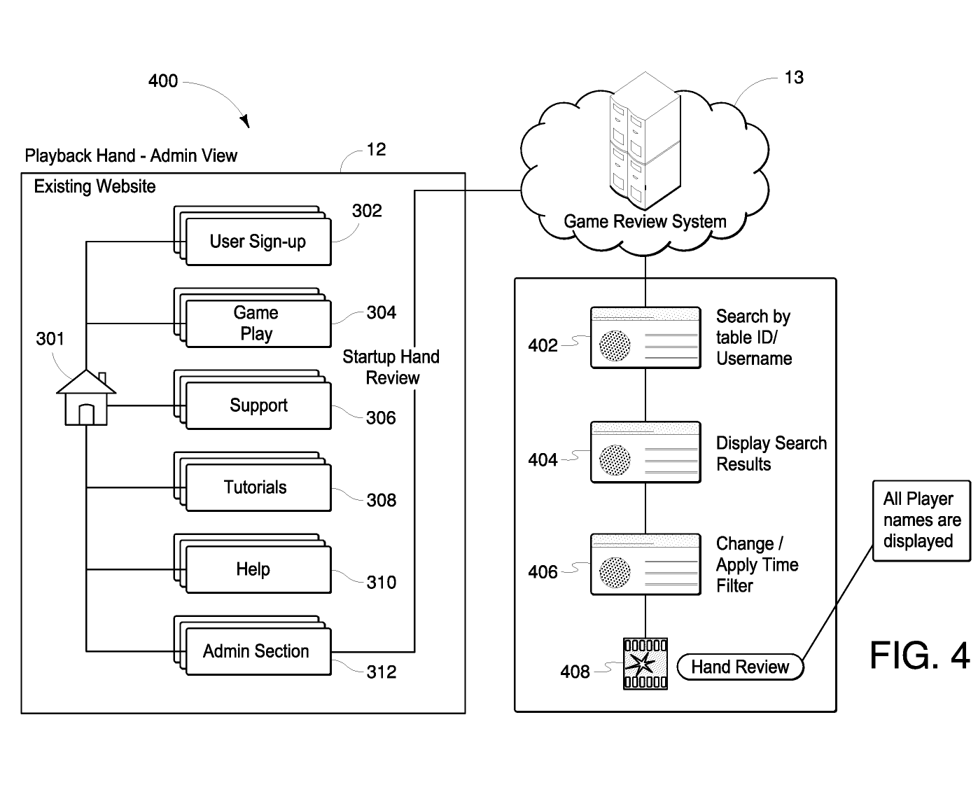

FIG. 4 is a functional block diagram illustrating a system 400 providing options available to an administrator, including the ability to review or play back a hand, in accordance with various embodiments. Some of the web pages available are similar to those shown in FIG. 3, and like reference numerals indicate like components.

In the embodiment shown in FIG. 4, game review is provided by a separate server 13 from the server 12 used for game play. In other embodiments, the functions of servers 12 and 13 are combined or provided by the same company or operator.

The system 400 includes admin pages 312 using which an administrator may perform administrative functions, such as in server 13, for example. From the admin pages 312, an administrator may search for a hand or game by Table ID and Username, or both in a search page 402. Search results are shown in a display search results page 404. In some embodiments, the results may be filtered, sorted, or the search may be changed in page 406. In response to a user specifying a hand to review, a game review animation or video 408 is generated and provided to the administrator.

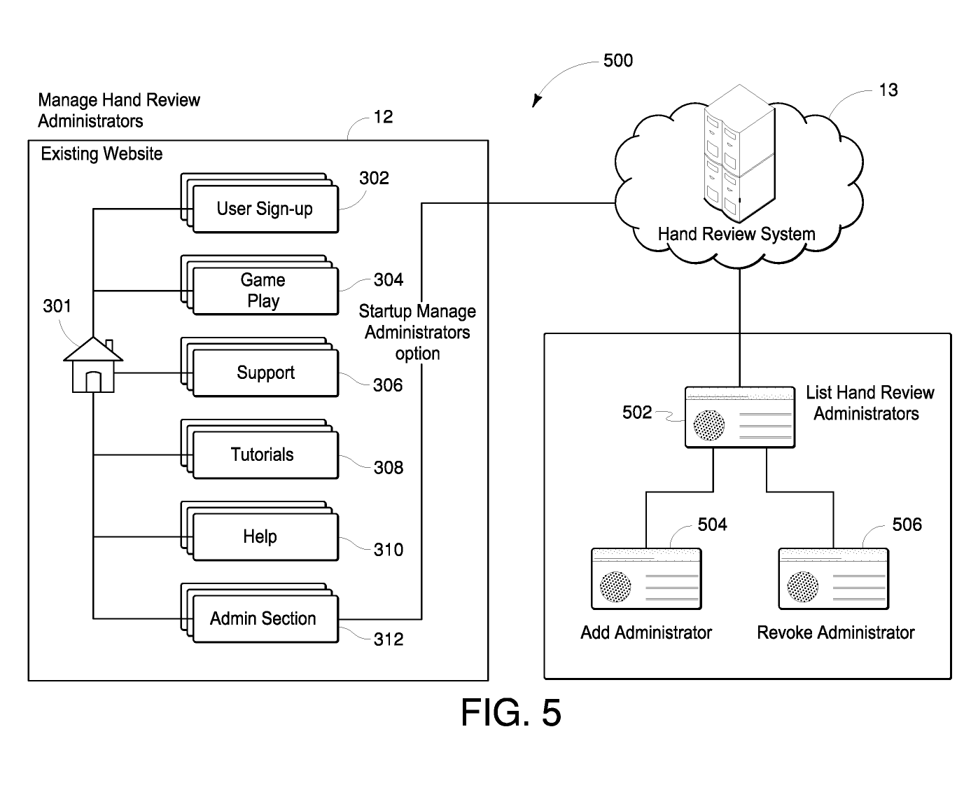

FIG. 5 is a functional block diagram illustrating a system 500 having options available to a super-administrator, including the ability to add or remove administrators, in accordance with various embodiments. Some of the web pages available are similar to those shown in FIG. 3, and like reference numerals indicate like components.

From the admin pages 312, a super-administrator may access a page 502 from which administrators may be added or deleted. For example, the page 502 may list existing administrators or otherwise allow administrators to be searched or sorted. Using page 504, an administrator may be added (e.g., an administrator at a casino or game host). This may involve granting a user additional rights (e.g., administrative rights). Using page 506, an administrator may be deleted (e.g., administrator rights revoked).

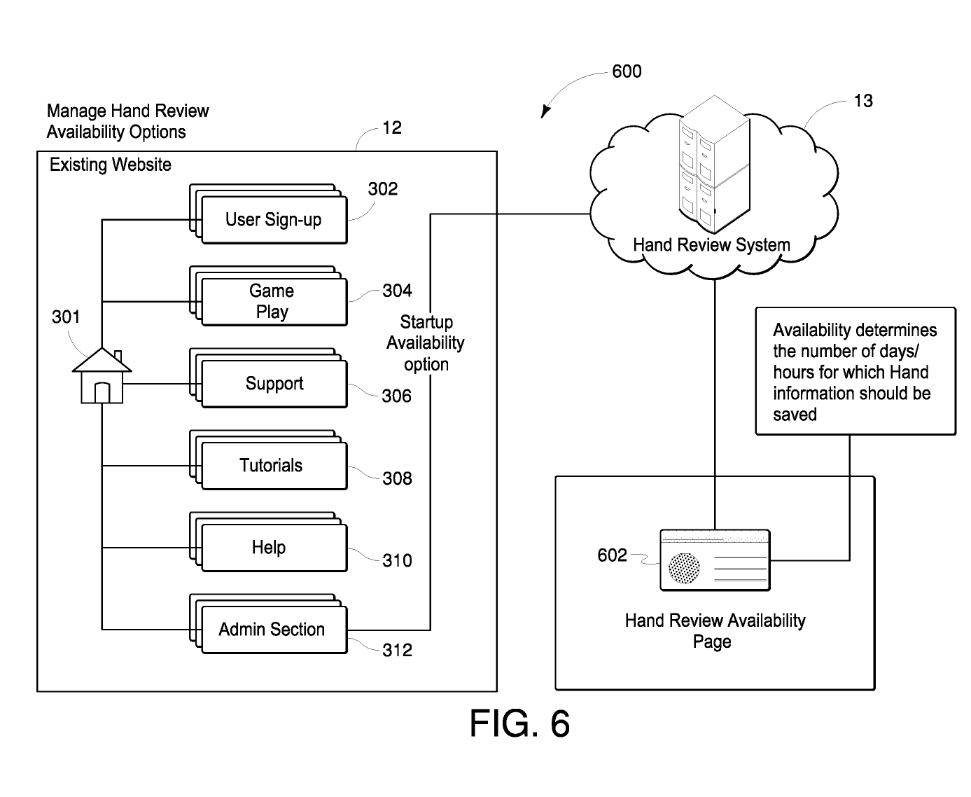

FIG. 6 is a functional block diagram illustrating a system 600 having availability settings for game review. Some of the web pages available are similar to those shown in FIG. 3, and like reference numerals indicate like components.

From the admin pages 312, an administrator may access a page 602 to set the amount of time (e.g., number of days, number of hours, or number of days and hours) for which game review should be saved for a hand. In some embodiments, a list of alternative amounts of time is provided. In other embodiments, a user may manually select an amount of time. In other embodiments, a list of alternatives is provided as well as the possibility of a manual selection. In some embodiments, game review information to generate videos or animations, or the videos themselves, are saved for an amount of time set by the page 602. In some embodiments, the information or videos are saved for this amount of time or until memory space is required. If memory is full, hand review information or videos are deleted on an oldest first basis if they cannot each be kept for the amount of time set in page 602. In some embodiments, other settings can also be changed.

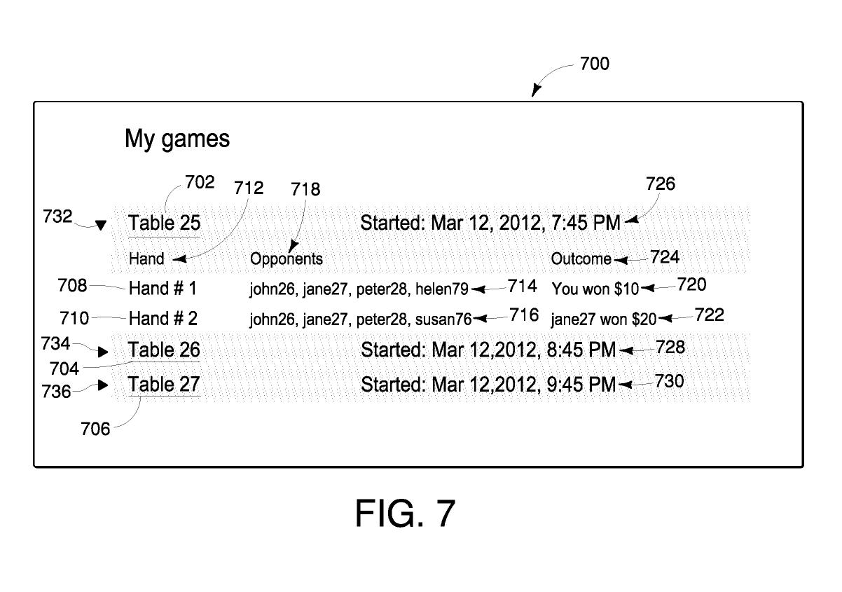

FIG. 7 shows a page 700 of game list administration, in accordance with various embodiments. In some embodiments, a prerequisite for a user reaching this page 700 is that the user is registered and authenticated on the gaming website (e.g., on server 12) that hosts the tables shown in FIG. 7. The page 700 is provided in response to the user opening hand review (e.g., from page 304), such as by actuating a link or button. The page 700 includes a list of tables 702, 704, 706 at which a player has played, in some embodiments. In some embodiments, the date, time, or both date and time 726, 728, and 730, at which game play started at a table, are displayed along with the table numbers. In some embodiments, if a table number is clicked, a list of hands 708, and 710 is illustrated under a Hand heading 712. In some embodiments, for respective hands 708 and 710, a list of opponents 714 and 716 is provided under an Opponents heading 718, and, in some embodiments, a list of outcomes 720 and 722 under an Outcome heading 726.

In some embodiments, icons 732, 734, and 736 are provided for respective tables 702, 704, and 706 that, when clicked on, provide an expand function in the case of icons 734 and 736, or a contract function, in the case of icon 732. For example, if icon 704 is clicked, a list of hands played at table 26 will be revealed. If icon 732 is clicked, the list of hands 708 and 710, list of opponents 714 and 716, list of outcomes 720 and 722, and headings 712, 718, and 726, will all be hidden. In some embodiments, the orientation of the icon or shape or color of the icon indicates whether there has been an expansion or could be an expansion.

In some embodiments, the list of tables 702, 704, and 706 is generated in response to a search similar to the search 402. The results may be limited by default to games played in a certain time frame, in some embodiments, or the time frame to search may be specified by the user or by default.

More particularly, in some embodiments, an administrator restricts the scope of available games (e.g., only games that occurred in the last 24 hours, the last 10 games, games that occurred in the last 24 hours but not the last hour, the last 10 games that did not occur in the last hour, etc.). In these embodiments, the server 12 or 13 hides tables and hands that do not correspond to the administrator-set criteria.

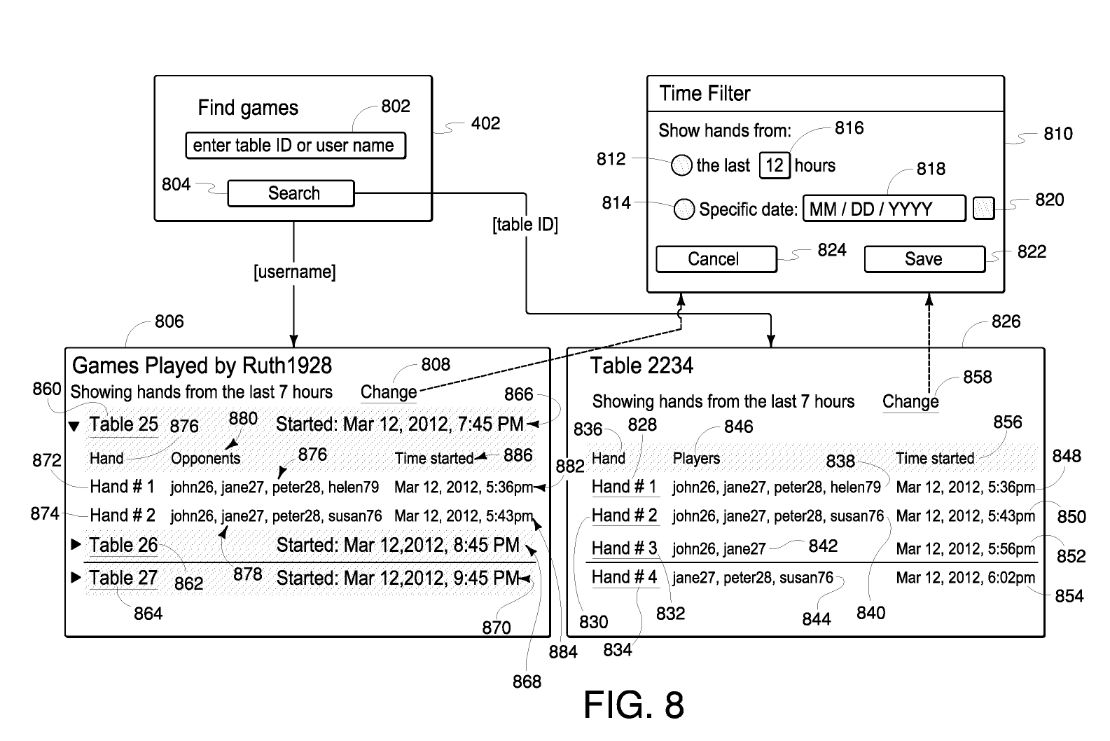

FIG. 8 is a logic flow diagram and also shows examples of various pages, such as results of various types of searches. FIG. 8 shows an example of a search dialog or page 402 that can be used in various embodiments, such as by an administrator. More particularly, in some embodiments, to reach the page 402, it is a pre-condition that a user is registered and authenticated on the website that hosts the tables and games shown in FIG. 8 (e.g., on server 12), and it is a pre-condition that the user has administrative privileges. In some embodiments, the page 402 is provided in response to the user opening hand review (e.g., from page 312), such as by actuating a link or button.

In the embodiment of FIG. 8, an administrator can enter either a table name, user ID or name, or player ID or name in a search field 802 and initiate a search, such as by actuating a search link or button 804. In the illustrated embodiment, it is not necessary to specify what type of ID has been entered, whether a table ID, or user or player name. The server 13 (or 12) determines what type of search is being requested, for example, by the format of the entry or by determining which database has a matching entry.

In some embodiments, if a user name is entered in the search field 802, a page 806 showing games matching the search criteria, is displayed.

The page 806 includes a list of tables 860, 862, and 864 at which a player has played, in some embodiments. In some embodiments, the date, time, or both date and time 866, 868, and 870, at which game play started at a table, are displayed along with the table numbers. In some embodiments, if a table number is clicked, a list of hands 872 and 874 is illustrated under a Hand heading 876. In some embodiments, for respective hands 872 and 874, a list of opponents 876, and 878 is provided under an Opponents heading 880, and, in some embodiments, a list of times games were started 882 and 884 under a Started heading 868. In the illustrated embodiment, a user can open a hand for review, or limit the displayed hands by time.

In the illustrated embodiment, the page 806 shows, by default, games played in a certain time frame, such as in the last 7 hours. This can be changed by actuating a Change link or button 808.

In response to the Change link or button 808 being actuated, a change dialog or page 810 is shown. The dialog 810 corresponds to the page 406 of FIG. 4. In the embodiment of FIG. 8, the page 810 allows a time filter to be applied, changed, or cleared. In some embodiments, a choice can be made, e.g., using a radio button 812 or 814, as to whether to filter by the last predetermined number of hours, or whether to specify a specific date. If filtering by the last predetermined number of hours, the number is entered in an hours field 816. If filtering by a specific date, the date is entered in a date field 818 or a calendar link or button 820 can be actuated and will bring up a calendar page from which a date can be clicked on. In response to actuating a link or button 822, the filtering is applied. In response to actuating a link or button 824, the filtering is cancelled and the page 810 is closed.

If a user ID is entered in the field 802, and the server 12 or 13 cannot find a player with the specified user ID, an error message is returned to the user (administrator), and the user is prompted to enter a different user ID or return, in some embodiments.

If a player did not play within the default or specified time filter, an error message is returned to the user (administrator). In some embodiments, the error message suggests that a different time filter be applied or that a larger time period be specified. For example, the error message may say “The Player didn't play any games within the specified time period. Try increasing the time period.” The user can then change the time filter, repeat the search, or return to the page from which they applied the filter (e.g., page 806 or 826).

If a table ID is entered in the field 402, a page such as page 826 is generated in response to the search button or link 804 being actuated. In the page 826, a list of hands 828, 830, 832, and 834 is illustrated under a Hand heading 836. In some embodiments, for respective hands 828, 830, 832, and 834, a list of opponents 838, 840, 834, and 844 is provided under an Opponents or Players heading 846, and, in some embodiments, a list of times started 848, 850, 852, and 854 under an Time started heading 856. A change button or link 858 is also provided, in the illustrated embodiment. In response to the Change link or button 856 being actuated, the change page 810 is shown.

If a table ID is entered in the field 802, and the server 12 or 13 cannot find the specified table, an error message is provided to the user, and the user is prompted to enter a different table ID, in some embodiments.

Thus, in the illustrated embodiment, from page 806 or 826, a user can open a hand for review, or limit the displayed hands by time.

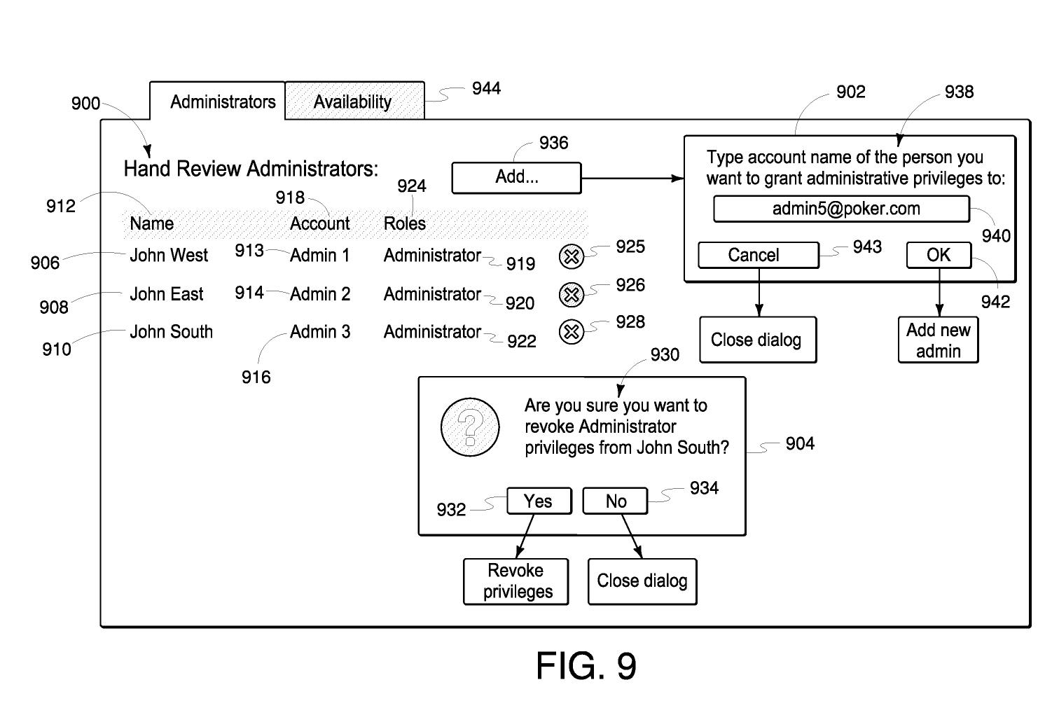

FIG. 9 is a logic flow diagram and also shows examples of various pages or dialogs, such as an administrator list page 900 and pages or dialogs for adding 902 or deleting 904 administrators. In some embodiments, the list page 900 corresponds to the page 502 of FIG. 5. In some embodiments, the dialog 902 corresponds to the page 504 of FIG. 5. In some embodiments, the dialog 904 corresponds to the page 506 of FIG. 5.

In the illustrated embodiment, the list page 900 includes names 906, 908, and 910 of administrators, under a Name heading 912. In some embodiments, the list 900 further includes account names or user IDs 913, 914, and 916, for respective users, under an Account heading 918. In some embodiments, the list page 900 further includes status or privilege descriptions 919, 920, and 922 for respective users, under a Roles heading 924. In the illustrated embodiment, icons or links 925, 926, and 928 are provided for respective users which, when actuated, bring up the dialog or page 904 for revoking administrative rights. In the illustrated embodiment, the icons or links 924, 926, and 928 indicate a deletion will occur. For example, they incorporate an “X” or a garbage can.

The dialog or page 904, in the illustrated embodiment, displays text 930 asking for confirmation of revocation of administrative rights and includes a confirmation or Yes button or link 932 and a cancel or No button or link 934. If the confirmation button or link 932 is actuated, privileges are revoked for the selected administrator. If the cancel button or link 934 is actuated, the dialog or page 904 is closed.

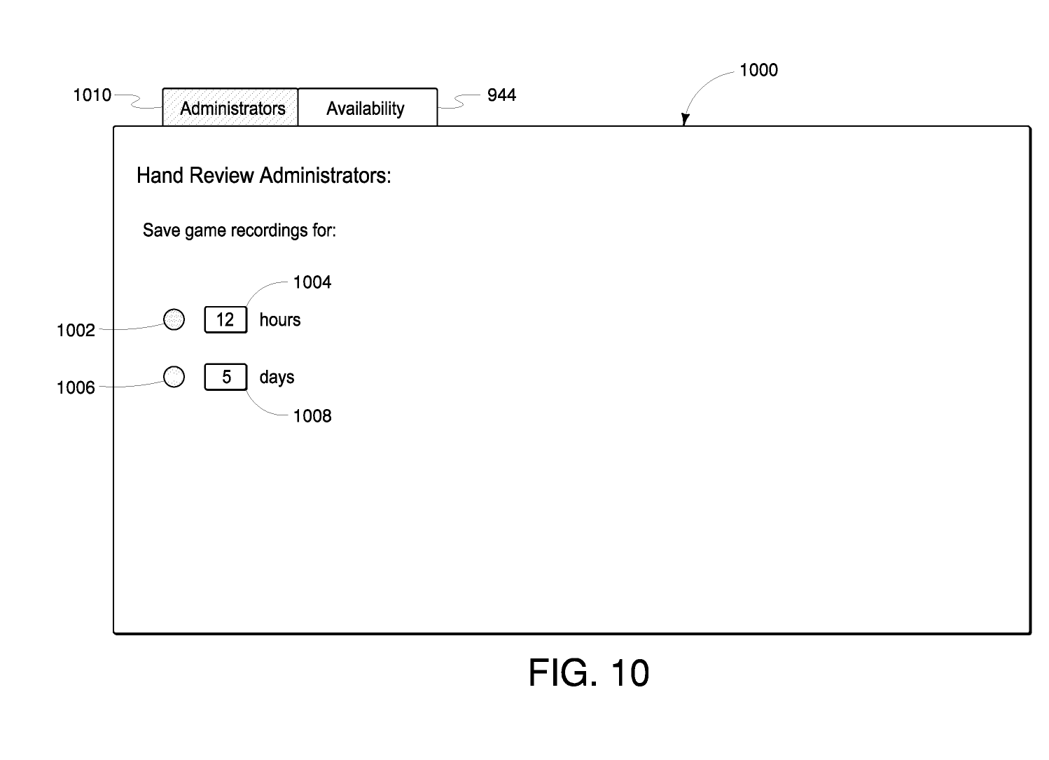

The list page 900, in the illustrated embodiment, further includes an Add button or link 936 which, when actuated, brings up the dialog or page 902. In the illustrated embodiment, the dialog or page 902 includes text instructions 938 to type the account name of the person to whom administrative privileges are to be granted and includes a field 940 in which a user ID, user name, or email address can be entered. The dialog or page 902 includes a confirmation or Yes button or link 942 and a cancel or No button or link 943. If the confirmation button or link 942 is actuated, privileges are granted for the indicated person or user. If the cancel button or link 943 is actuated, the dialog or page 902 is closed. In some embodiments, the list page 900 also includes a tab, link, or button 944 which, when actuated, brings up the availability page described below in connection with FIG. 10.

In some embodiments, if the server 12 or 13 didn't find a user with the specified user ID, user name, or email address, an error message is returned indicating that no such user could be found. The error message could also state that the search could be repeated or cancelled. For example, the error message could state something like: Cannot find user % username %. User can repeat search or cancel basic scenario. % username % is a variable indicating the data entered in the field 940.

FIG. 10 is a screen shot of an availability page 1000. In some embodiments, the availability page 1000 corresponds to the page 602 of FIG. 6. In the illustrated embodiment, from the page 1000, an administrator may set the amount of time (e.g., number of days, number of hours, or number of days and hours) for which game review should be saved for a hand. In the illustrated embodiment, an administrator may actuate a radio button or other selector 1002 to make a selection in terms of a number of hours, and enters the number of hours in a field 1004. Game recordings (or data to generate the videos or animations) will then be saved for the indicated number of hours. An administrator may actuate a radio button or other selector 1006 to make a selection in terms of a number of days, and enters the number of days in a field 1008. Game recordings will then be saved for the indicated number of days. In some embodiments, the availability page 1000 also includes a tab, link, or button 1010 which, when actuated, brings up the administer list page described above in connection with FIG. 9.

In some embodiments, if a user (administrator) specifies a period of time shorter than the current setting, the server 12 or 13 returns a message indicating that all recordings (or data used to generate recordings) outside the specified time frame will be deleted, and request confirmation.

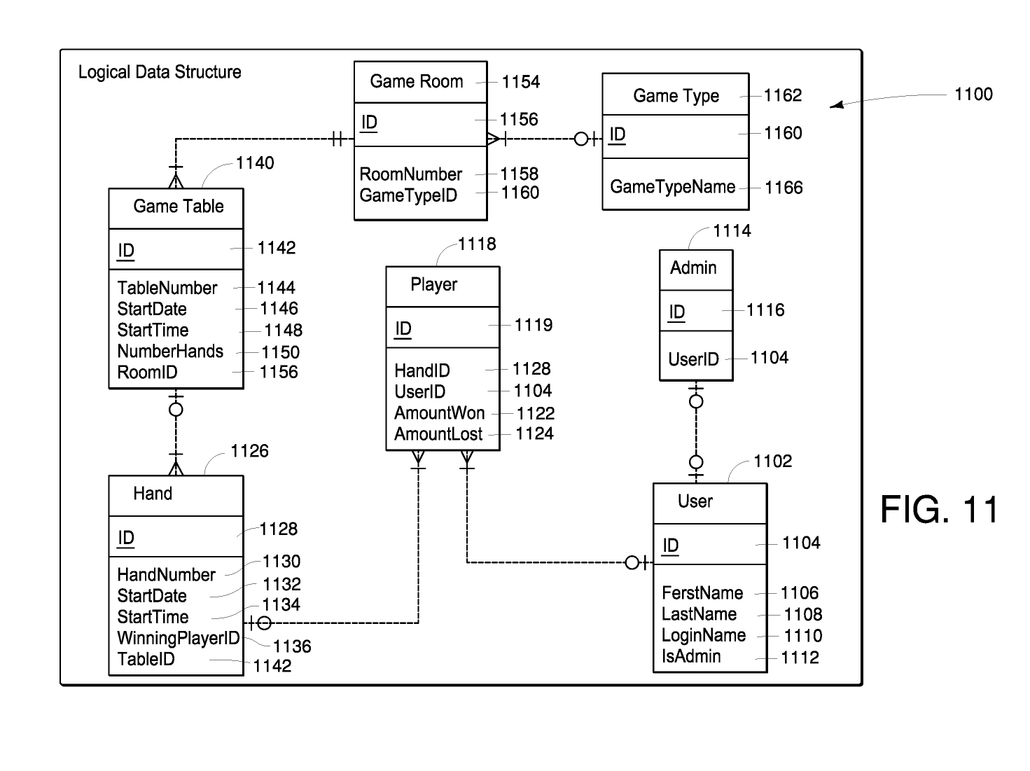

FIG. 11 is a database schema diagram in accordance with various embodiments. The databases 16 and 17 of FIG. 1 include the databases 1100 shown more specifically in FIG. 11. The databases 1100 include, for example, a user database 1102. The user database 1102 includes, for example, respective entries or records for user IDs 1104, first names 1106, last names 1108, login names 1110, and entries 1112 indicating whether a user is an administrator. More particularly, in some embodiments, respective entries or records in this database represent a registered member of the site who is eligible to play a game. In the illustrated embodiment, users 1104 are parents of players 1119 (described below). In the illustrated embodiment, each user 1104 may have played a game on one or more occasion and may have multiple references in a player database 1118 described below. In the illustrated embodiment, users 1104 are parents of administrators 1116 (described below). In the illustrated embodiment, each user 1104 may be an administrator 1116, if designated as an administrator (e.g., by a super-administrator).

The databases 1100 further include an admin (administrator) database 1114. The admin database includes, for example, respective entries for admin IDs 1116, and user IDs 1104. An administrator is a user with administrative privileges.

The databases 1100 further include a player database 1118. The player database 1118 includes, for example, respective entries for player IDs 1119, hand IDs 1128, user IDs 1104, and at least one of amount won 1122 and amount lost 1124. In other embodiments, amount won can include negative numbers instead of there being a separate amount lost entry, or amount lost can include negative numbers instead of there being a separate amount won entry. More particularly, in some embodiments, respective entries or records in this database represent a single player who is playing or has played a game at a game table. In the illustrated embodiment, players 1119 are children of hands 1128 (described below). In the illustrated embodiment, each player 1119 must belong to a single hand 1128 (described below). In the illustrated embodiment, players 1119 are children of users 1104. In the illustrated embodiment, each player 1119 must belong to a single user 1104.

The databases 1100 further include a hand database 1126. The hand database 1126 includes, for example, respective entries for hand IDs 1128, hand numbers 1130, start dates 1132, start times 1134, winning player ID 1136 (e.g., one or more of the player IDs 1119), and table IDs 1142 (described below). More particularly, in some embodiments, respective entries or records in this database represent a single game (e.g., hand or round) played at a game table 1142 (described below). In the illustrated embodiment, hands 1128 are parents to players 1119. In the illustrated embodiment, one hand must have at least one player. In a more particular embodiment, for a game that requires more than one player, one hand must have more than one player. In the illustrated embodiment, hands 1128 are children of game tables 1140, described below. In the illustrated embodiment, each hand 1128 must belong to one and only one game table 1142 (described below).

The databases 1100 further include a game table database 1140. The game table database 1140 includes, for example, respective entries for game table IDs 1142, table numbers 1144, start dates 1146, start times 1148, number of hands 1150, and room IDs 1156. More particularly, in some embodiments, respective entries or records in this database represent a game that is either underway or completed and that has at least one player. In more particular embodiments, for games that require more than one player, respective entries or records in this database represent a game that is either underway or completed and that has more than one player. In the illustrated embodiment, game tables 1142 are parents to hands 1128. In the illustrated embodiment, one game table must have one or more hands.

The databases 1100 further include a game room database 1154. The game room database 1154 includes, for example, respective entries or records for game room IDs 1156, room numbers 1158, and game type IDs 1160. More particularly, in some embodiments, respective entries or records in this database represent a single poker room or game room that can have one or more games or tables being played concurrently. In the illustrated embodiment, game rooms 1156 are parents to game tables 1142. In the illustrated embodiment, one game room must have one or more game tables. In the illustrated embodiment, game rooms 1156 are children of game types 1160, described below. In the illustrated embodiment, each game room 1156 must belong to one and only one game type 1160 (described below).

The databases 1100 further include a game type database 1162. The game type database 1162 includes, for example, respective entries or records for game type IDs 1160, and game types names 1166. More particularly, in some embodiments, respective entries or records in this database represent a single game type (e.g., a type of poker, such as Texas Holdem or Omaha, or other type of game). In the illustrated embodiment, game types are parents to game rooms. In the illustrated embodiment, one game type 1160 may have one or more game rooms 1156.

The illustrated database entries and organization are provided by way of example only. Various alternatives are possible.

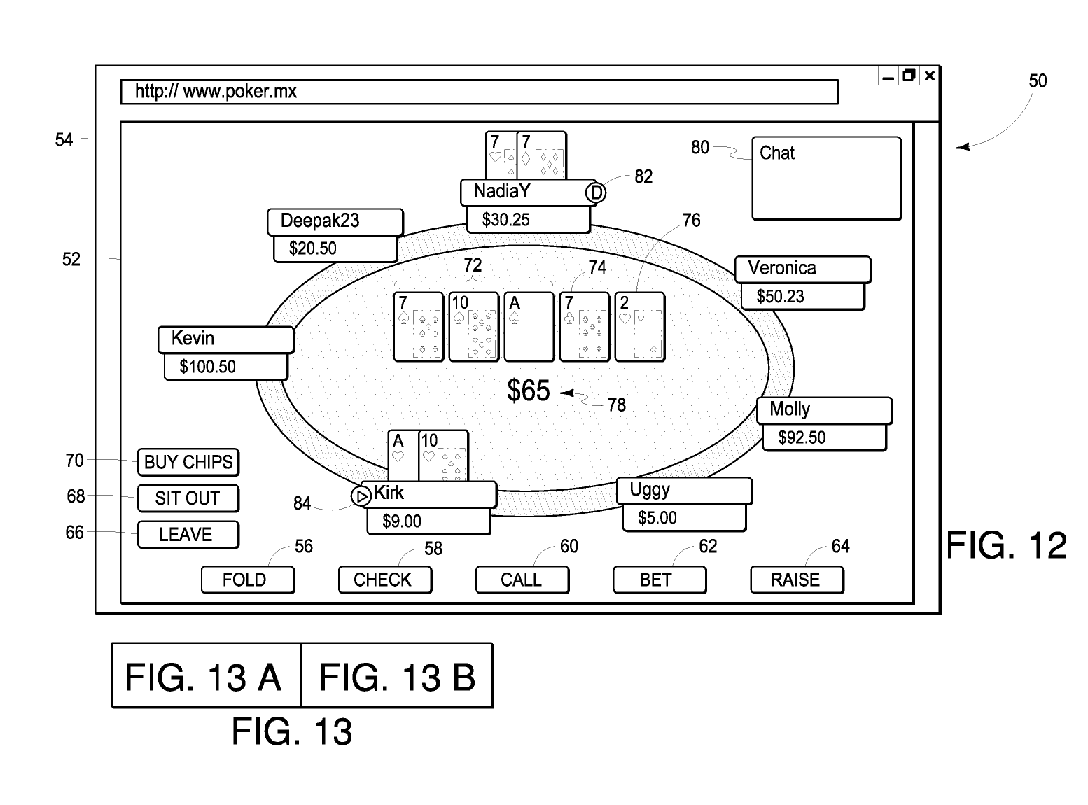

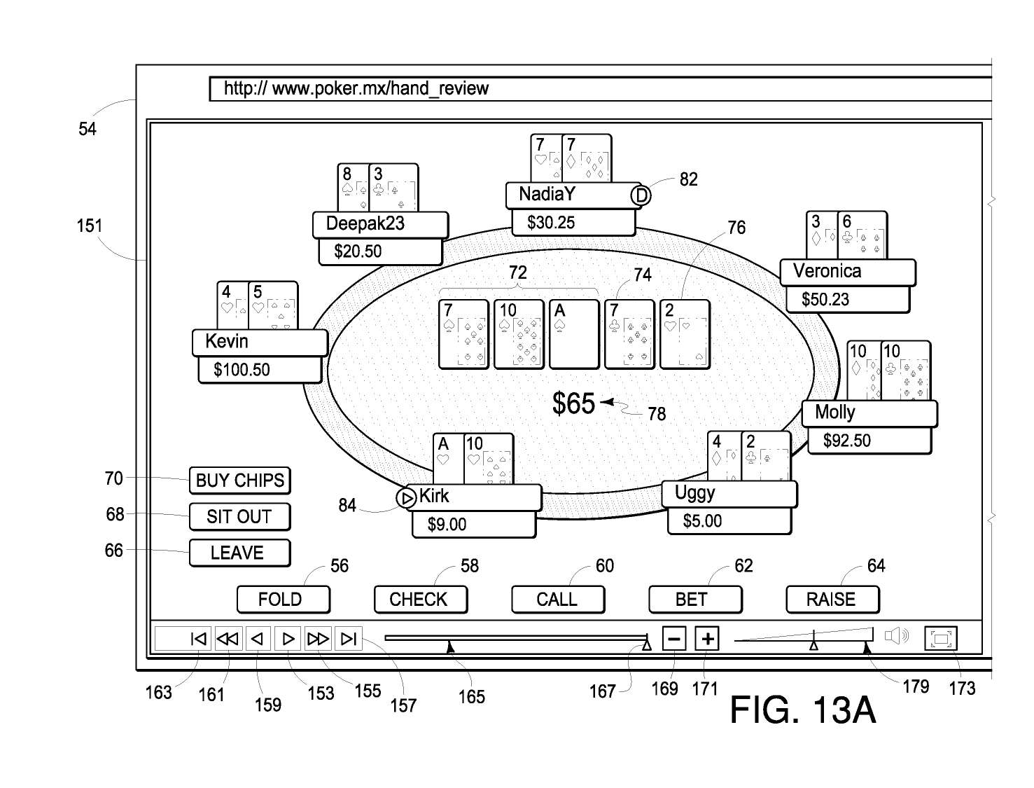

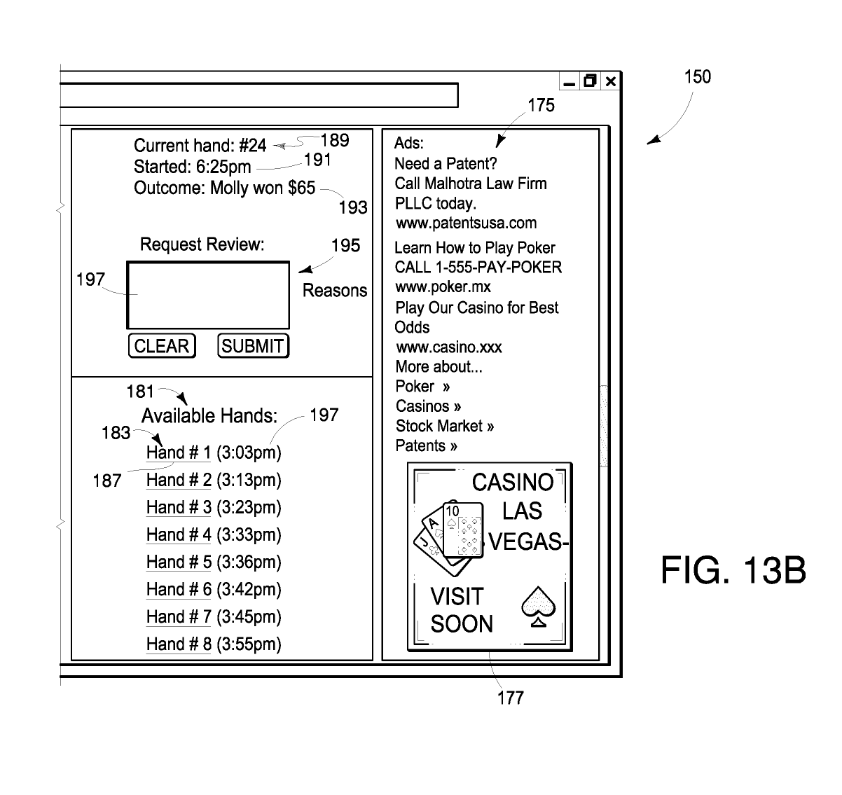

While various embodiments can be used with any of a variety of games, FIGS. 12 and 13 illustrate screen shots in which Texas Hold'em is being played, by way of example only. The rules are known in the art but will be summarized herein so one of ordinary skill can better understand how to use and make various embodiments, and also various advantages.

Each card counts as its poker value. Aces may be high or low. One player is designated as the “dealer” (though dealing is performed by computer in online gaming), players take turns being designated as dealer, and status as dealer is usually indicated somehow. A player to the left of the dealer's left must make a “small blind” bet. A player to the left of the small blind must make a “big blind” bet. These amounts get some money or tokens started in a pot. Two cards are dealt down to each player. The player to the left of the big blind must call, fold, or raise the big blind bet. The play goes around the table according to normal poker rules. The small blind may raise the big blind. If nobody raises the big blind, the player making the big blind has the option to raise his own bet. Three community cards are dealt face up. This is called the “flop.” After the flop is dealt, another round of betting takes place. A fourth community card is dealt face up and is called the “turn.” Another round of betting takes place. A fifth, and final, community card will be dealt face up and is called the “river.” Another round of betting takes place. Each player still in the game determines his or her highest poker value among his or her own two cards and the five community cards. The player does not need to use one or both of his or her own cards. The player with the hand of highest poker value wins.

FIG. 12 illustrates a screen shot 50 at the end of a hand of normal game play. Game play can be represented in, for example, a flash or shockwave applet 52, in a browser 54 or in a downloaded program. In the illustrated embodiment, buttons or controls are available for standard game play input options, such as a button 56 which an online player can use to Fold, button 58 which an online player can use to Check, button 60 which an online player can use to Call, button 62 which an online player can use to Bet, and button 64 which an online player can use to Raise. Different game play input controls are provided for different game types. In some embodiments, only buttons relevant to a player at any particular moment are illuminated or shown at all (or only appear when it is the player's turn to play). Other controls or buttons relevant to the game can also be displayed, such as a button 66 that a player can use to leave the game, a button 68 that a player can use to sit out of a hand, and a button 70 that a player can use to buy chips or tokens for wagering. FIG. 11 also shows a game table with a flop 72, turn 74, and river 76 shown in the middle (not the absolute center but between the players). A pot amount 78 can also be shown on the table or elsewhere on the page. A chat window, feature, or popup 80 can be provided. Features such as a dealer marker 82, current player 84, or any other feature typically used in online poker (or other game) can be provided. Similar indicators can be provided proximate player names to indicate who has folded, checked, called, or raised, or these actions can be indicated in the chat window 80.

As illustrated in FIG. 12, after a hand concludes, a player only sees the flop, turn, river, and final hands of those players who played to the end without folding.

FIGS. 13A and B, on the other hand, illustrate a screen shot 150 showing hand play. A video player 151 (e.g., a browser plug in or stand-alone player), or flash or shockwave applet plays a video file or animation that shows a sequence of card plays from start to finish of the hand (or for a portion of the hand). Controls typically found on a video player are included, such as a play and pause toggle button 153, a fast forward button 155, a fast forward to end button 157, a review (play backward) button 159, a rewind (play backwards quickly) button 161, and a fast rewind to beginning button 163. Other controls can be included such as a control 165 that shows the position in the video, an indicator 167 can be grabbed and moved to manipulate the position in the replay, speed down and up buttons 169 and 171, a volume control 179 and zoom to full screen button 173, sound volume control (not shown), share frame via email or social media (not shown), or any desired subset of these controls, or other video controls, can also be included. In some embodiments a list 181 of other hands that can be reviewed is displayed proximate or adjacent the animation or video player. The list 181 can include hands 183 played at the same table or played recently by the same player. The list 181, in the illustrated embodiment, also indicates the time 185 when respective hands were played. In the illustrated embodiment, the list 181 further includes links 187 that, when actuated, will initiate a video or animation providing hand review of the selected hand. In the illustrated embodiment, an indication 189 of the identification of the current hand being reviewed is also provided as part of the animation or video, or adjacent to the video player. Other information such as time started 191 and outcome 193, are also provided, in the illustrated embodiment. In some embodiments, context-relevant ads, or other ads 175 are displayed to generate revenue for the operator of the hand review system 13, particularly if it is provided as an add-on feature to an existing game website. The casino or game provider of the server or system 12 can easily generate revenue through wagering. It is more difficult for the operator of the hand review server or system 13. In some embodiments, larger display ads 177 are shown instead of or in addition to the smaller ads 175. FIG. 13 illustrates the end of a hand play, and shows the cards of all players, whether or not they folded during the hand. In some embodiments, a mechanism for a player or user to report a suspicion of fraud to an administrator of a game site or server 12 is also provided. This can be done, for example, with an interface 195, proximate the video player, including, for example, a box in which reasons for requesting review can be typed by the player or user. In alternate embodiments, a form is provided to a player or user, or the player or user may send an email requesting review of a certain hand, and identifying the hand. An email address for such requests is provided proximate the video player or in the hand review videos themselves, in some embodiments.

With online poker, it is typically hard to accuse someone of cheating on one specific hand. However, cheaters typically leave a trail of suspicious hands. For example, there are times when multiple players in the hand have very strong hands but do not use them normally.

The following is an example of a suspicious hand where cheating most likely occurred, referring to FIGS. 12 and 13. Assume there are seven players at the table.

Player a (“Kevin” in FIGS. 12 and 13) folds;

Player b (“Deepak23”) folds;

Player c (“NadiaY”) raises;

Player d (“Veronica”) folds;

Player e (“Molly”) calls (matches the raised bet of player c);

Player f (“Uggy”) folds; and

Player g (“Kirk”) calls (matches the raised bet of player c).

Player c has a 7 of hearts and 7 of diamonds.

Player e has a 10 of diamonds and 10 of clubs.

Player g has an Ace of hearts and 10 of hearts.

The flop comes as a 7 of spades, 10 of spades, and Ace of spades. There is $65 in the pot.

Player c checks (passes);

Player e bets $40; and

Players g and c call.

The turn card is a 7 of clubs.

Players c and e check;

Player g (having top two pair), a strong hand bets $100;

Player c (having 4 of a kind) calls;

Player e folds, while having a very strong hand with a full house.

With typical card play, as illustrated in FIG. 12, a player (e.g., player g) would have no reason to suspect any foul play. However, with hand review as illustrated in FIG. 13, he (and the house) would believe that player c and e are in collusion together. In some embodiments, player g could request a further investigation into those two players. Without hand review, situations like this may never be detected. In the illustrated embodiment, with hand review, all players' cards, including the players that folded before the flop, will be exposed.

The hand review page of FIG. 13 shows a video or animation of the sequence of cards being played during gameplay, with all hole cards exposed, and with the game played in its entirety (if desired). The hand review may or may not have the same, or original graphics as when the hand was played. Advertising logos may or may not be added to the review table. While reviewing, a hand fast forward option may or may not be available, along with other navigation features such as for skipping to the flop, turn or river.

A website with session review or hand review as described herein is expected to achieve a tremendous amount of traffic from the players. This will create advertising opportunities. In some embodiments, some or all of the revenue from advertising is given back to the players via freerolls and funds added to tournaments or pots. This is another reason why a player will want to play on systems using various embodiments, be they an already established online player, or a player playing for their first time.

Various specific embodiments have been described herein, to better enable one of ordinary skill in the art to make and use the invention. However, it should be understood that these are examples, only, and various embodiments are employed with different types of card games, different numbers of players, with or without wagering, etc. A few alternatives are as follows.

In some embodiments, hand review software can be added to any online card room.

In various embodiments, a host online card room can offer session review at one or more tables.

In various embodiments, hand review is used at the host website or an alternate website or both.

In various embodiments, a client (a card player) can view any one or all hands in which they participated.

In various embodiments, server 12, or another server 13 controlled by the operator or administrator of a hand review website or server, will store relevant data; i.e., hands recorded, for a determined period of time.

In various embodiments, after a hand is completed, a predetermined amount of time must elapse before that hand is eligible for review.

A player (client) is charged for using hand review in some embodiments. In other embodiments, a player is not charged for using hand review.

In some embodiments, a host site charges a fee to a player for using hand review. In other embodiments, a host site charges no fee.

In some embodiments, hand review is used for tournament card games. In some embodiments, hand review is used for real money card games.

While some embodiments disclosed herein are implemented in software, alternative embodiments comprise hardware, such as hardware including digital logic circuitry.

Still other embodiments are implemented in a combination of software and digital logic circuitry.

Various embodiments comprise a computer-usable or computer-readable medium, such as a hard drive, solid state memory, flash drive, floppy disk, CD (read-only or rewritable), DVD (read-only or rewritable), tape, optical disk, floptical disk, RAM, ROM (or any other medium capable of storing program code) bearing computer program code which, when executed by a computer or processor, or distributed processing system, performs some or all of the functions described above.

Some embodiments provide a carrier wave or propagation signal, medium, or device embodying such computer program code for transfer of such code over a network or from one device to another.

The subject matter disclosed in the drawings and above and below has been described in language more or less specific as to structural and methodical features. The description only discloses example embodiments. Alternatives are contemplated.

I/We claim:

1. A system for detecting collusion between players in a multi-player card online game involving wagering, in which sequential hands are played in multiple simultaneous tables, and in which, in a hand played, a first player cannot see all the cards dealt to other players, the system comprising:
a server configured to host the multi-player card game involving wagering, the server including a memory defining a database, and configured to receive multiple simultaneous connections from user client devices via a network, the first server being configured to provide a user interface to respective client devices simulating a game table, including to a first client device for a first user, to a second client device for a second user, and to a third client device for a third user, wherein the first and second users of the first, second, and third client devices may play a hand against each other at the game table using the first module;
a module configured to keep track of cards dealt to respective users at the game table, including cards dealt to the second user that the first user is not able to see, for respective hands, and to save dealt card information for respective hands;
a module configured to generate a hand review video file illustrating how one of the hands was played, in which cards dealt to the first user, the second user, and third user are revealed; and
a module configured to provide a page, to the first client device, including a form using which the first user may report suspected collusion between the second and third users to an administrator of the online game.

2. A system in accordance with claim 1 wherein the form using which the first user may report suspected collusion includes a text box into which a user can enter reasons why the first user suspects collusion between the second and third players.

3. A system in accordance with claim 1 and configured to provide to the first client device a page including a list containing tables at which the first user has played, hands played at respective tables, and times at which game play started for respective hands, using which the first user is able to use to select a hand to obtain the video file for the selected hand.

4. A system in accordance with claim 3 wherein the list containing tables only displays games played within a time period extending a predetermined amount of time into the past.

5. A system in accordance with claim 1 wherein the server is operated by a first casino, the system further comprising a second server configured to operate a multi-player card game for a second casino, and the system comprising a third server, in communication with the first and second servers, configured to selectively generate a super-administrator admin account page using which one of the users, a super-administrator administering multiple casinos, can grant and revoke administrative rights to users who are administrators of the servers operated by the first and second casinos.

6. A system in accordance with claim 5 and configured to generate a page accessible by one of the administrators which can be used to set the minimum amount of time for which the hand review video file should be saved.

7. A system in accordance with claim 1 wherein the user interface simulating a game table displays advertisements proximate the game table.

8. A system in accordance with claim 1 wherein the video file includes recorded advertisements.

9. A system in accordance with claim 1 wherein the user interface simulating a game table displays advertisements proximate the game table during game play and wherein the video file includes recorded advertisements that are different from the advertisements displayed during game play.

10. A system in accordance with claim 1 wherein the user interface simulating a game table displays advertisements proximate the game table during game play and wherein the video file includes recorded advertisements that are the same as the advertisements displayed during game play.

11. A system in accordance with claim 1 and configured to cause the first user device to launch a player for playing the video file, the player including controls for pause, fast forward, and reverse.

12. A system in accordance with claim 11 and configured to display, on the first user device, adjacent the player, a list of other hands for which hand review video files are available.

13. A system in accordance with claim 12 and configured to, in response to the first user selecting one of the hands from the list of other hands, cause the player to play the video for the selected hand from the list of other hands.

14. A method of detecting collusion between players in a multi-player online card game involving wagering, in which sequential rounds are played in multiple simultaneous tables at servers hosted by multiple casinos, and in which, in a round on a table hosted by one of the servers, a player cannot see all the cards dealt to other players, the method comprising:
receiving, at a first server managed by a first administrator of a first casino, a request from a first one of the players to play at a first table of the first casino;
receiving an online wager from the first player at the first table;
using the first server, electronically dealing cards to the players, including the first player, at the first table in a first round;
during the first round, receiving game play inputs at the first server from respective players as the round is played, the inputs representing selection of game play options, in a sequence as game play progresses from player to player;
receiving, at a second server managed by a second administrator of a second casino, a request from a second player to play at a second table of the second casino;
receiving online wagers from respective players at the second table;
using the second server, electronically dealing cards to the players, including the second player, at the second table in a second round;
during the first round, receiving game play inputs at the first server from players of the first table as the round is played, the inputs representing selection of game play options, in a sequence as game play progresses from player to player;
during the second round, receiving game play inputs at the second server from players of the second table as the round is played, the inputs representing selection of game play options, in a sequence as game play progresses from player to player;
at a third server, administered by a super-administrator capable of granting or revoking administrator rights to users of the first and second servers, keeping track of cards dealt to players at the first table and at the second table, including cards that the first and second players are not able to see, for respective rounds;
generating first and second round review video files illustrating how the first and second rounds were played, in which cards dealt to all players of the first and second rounds are revealed, and in which game play inputs made by players are indicated;
after an amount of time after the first round has concluded, the amount of time being selectable by the first administrator, providing an interface to the first player using which the first player can request a review of the first round if the first player suspects collusion between other players of the first round;
receiving from the first player a request to review the first round, the request including information identifying the first round; and
in response to receiving the request to review the first round, transmitting the first round review video file to the first player.

15. A method in accordance with claim 14 and further comprising storing the first video file in a memory for an amount of time input by the first administrator using an interface.

16. A method in accordance with claim 14 and further comprising providing, to the first player, a page listing tables, and rounds, played at respective tables, that the first user is able to use to select the first round for review.

17. A system for detecting collusion between players in a multi-player card online game involving wagering, in which sequential hands are played in multiple simultaneous tables, and in which, in a hand played, a first player cannot see all the cards dealt to other players, the system comprising:
a server configured to host the multi-player card game involving wagering, the server including a memory defining a database, and configured to receive multiple simultaneous connections from user client devices via a network, the first server being configured to provide a user interface to respective client devices simulating a game table, including to a first client device for a first user, to a second client device for a second user, and to a third client device for a third user, wherein the first and second users of the first, second, and third client devices may play a hand against each other at the game table using the first module, the server being configured to provide advertising in the user interface;
a module configured to keep track of cards dealt to respective users at the game table, including cards dealt to the second user that the first user is not able to see, for respective hands, and to save dealt card information for respective hands;
a module configured to generate a hand review video file illustrating how one of the hands was played, in which cards dealt to the first user, the second user, and third user are revealed, the hand review video file including advertising; and
a module configured to provide a page, to the first client device, including a form using which the first user may report suspected collusion between the second and third users to an administrator of the online game, the form including a text box in which a user can enter reasons why the first user suspects collusion between the second and third players.

18. A system in accordance with claim 17 wherein the server is operated by a first casino, the system further comprising a second server configured to operate a multi-player card game for a second casino, and the system comprising a third server, in communication with the first and second servers, configured to selectively generate a super-administrator admin account page using which one of the users, a super-administrator administering multiple casinos, can grant and revoke administrative rights to users who are administrators of the servers operated by the first and second casinos.

19. A system in accordance with claim 18 and configured to generate a page accessible by one of the administrators which can be used to set the minimum amount of time for which the hand review video file should be saved.

20. A system in accordance with claim 18 and configured to cause the first user device to launch a player for playing the video file, the player including controls for pause, fast forward, and reverse.
